(19) United States
(12) Patent Application Publication
(10) Pub. No.: US 2025/0391189 A1
(43) Pub. Date: Dec. 25, 2025

(54) DETECTING AND PROCESSING REPEATING STRUCTURE GROUPS OF OBJECTS IN A DOCUMENT

(71) Applicant: Adobe Inc., San Jose, CA (US)

(72) Inventors: Palak AGARWAL, Kanpur (IN); Parth PATEL, Vadodara (IN); Yuvraj RAGHUVANSHI, Varanasi (IN); Mohit GUPTA, Noida (IN); Harish AGARWAL, Jaipur (IN); Ankit BAL, Noida (IN)

(73) Assignee: Adobe Inc., San Jose, CA (US)

(21) Appl. No.: 18/752,399

(22) Filed: Jun. 24, 2024

(51) Int. Cl. G06V 30/19; G06V 30/148; G06V 30/412; G06V 30/414

(52) U.S. Cl. CPC G06V 30/19013; G06V 30/158; G06V 30/412; G06V 30/414

(57) ABSTRACT

Embodiments are disclosed for a process of detecting and processing repeating structure groups of objects in a document using a digital design system. The method may include obtaining, by a page segmentation model, object information for a plurality of objects in a document. The disclosed systems and methods further comprise determining, using the object information, a plurality of object clusters based on distances between the plurality of objects. A repeating structure group of objects can then be identified using the plurality of object clusters. The disclosed systems and methods further comprise providing information indicating the repeating structure group of objects in the document

### BACKGROUND

The content of a document can include any combination and number of objects, including text, figures, headings, footnotes, tables, and list-items. Some document types, including portable document format (PDF) documents do not have any structural information, but instead have a content stream that includes information on how to render the content on the page. For example, figures that would form a single logical unit may be made up of hundreds of path elements in the PDF content stream. In another example, instead of paragraph or text lines in a PDF document, text is typically formed using a sequence of commands that indicate the placement of characters at different positions on the page. However, because PDF documents do not have structure informational, understanding the relationship between the various objects in a PDF document can pose challenges for identification and editing.

### SUMMARY

Introduced here are techniques/technologies that allow a digital design system to identify and process objects in a document, such as a portable document format (PDF) document, to identifying repeating structure groups of objects.

More specifically, in one or more embodiments, a digital design system processes a document through a pipeline to identify objects in the document. Example types of objects can include heading, text, figure, footnote, table, and list-item. The digital design system then processes the objects data to generate data representing repeating structure groups of objects, or repeating groupings of objects, in the document. Repeating structure groups of objects are structures/templates that appear multiple times within and across a document. For example, a repeating structure group of objects can be made up of multiple merged object cluster units with the same or similar arrangement of objects that have the same or similar attributes. One example of a merged object cluster unit can be a figure object, a heading object, and a text object. Another example of a merged object cluster unit is a heading object and multiple text objects. Once the repeating structure groups of objects are determined, the data representing a repeating structure group of objects can be used by downstream applications to facilitate the editing of objects within merged object cluster units and/or the creation of new merged object cluster units in a same or different document.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of detecting and processing repeating structure groups of objects in a document in accordance with one or more embodiments;

FIG. 2 illustrates a diagram of a repeating objects detection module for identifying repeating structure groups of objects in a document in accordance with one or more embodiments;

FIG. 3 illustrates an exemplary document for processing through a digital design system to detect repeating structure groups of objects in accordance with one or more embodiments;

FIG. 4 illustrates the result of processing a document through a page segmentation model in accordance with one or more embodiments;

FIG. 5 illustrates the result of processing the objects predicted by a page segmentation model using a repeating objects detection module in accordance with one or more embodiments;

FIG. 6 illustrates a process of applying a structure of a source repeating structure group of objects template to content in a target repeating structure group of objects in accordance with one or more embodiments;

FIG. 7 illustrates a schematic diagram of a digital design system in accordance with one or more embodiments;

FIG. 8 illustrates a flowchart of a series of acts in a method of detecting and processing repeating structure groups of objects in a document in accordance with one or more embodiments;

FIG. 9 illustrates a flowchart of a series of acts in a method 900 of generating repeating structure group of objects using a repeating structure group of objects template in accordance with one or more embodiments; and

FIG. 10 illustrates a block diagram of an exemplary computing device in accordance with one or more embodiments.

### DETAILED DESCRIPTION

One or more embodiments of the present disclosure include a digital design system for identifying and processing repeated groupings of objects in a document. Existing techniques for document layout analysis are limited to the task of information retrieval from documents. For example, some existing techniques can create labeled bounding boxes for objects identified on a page, but they cannot determine when objects are repeating objects. Thus, when a user wants to make changes to an element, such as change font size, type, etc., with existing techniques, changes have to be made manually to every object individually. Other existing techniques can parse the structure of a document to create a hierarchy of objects. While this works for well-structured documents (e.g., research paper-like documents, multi-column files, etc.), it is not suitable for visually-rich documents (e.g., brochures, flyers, presentations, etc.).

To address these and other deficiencies in conventional systems, embodiments of the present disclosure utilize a heuristic-based method to identify repeating structure groups of objects in a document, such as a portable document format (PDF) document. A repeating structure group of objects is a set of objects that appear together in a same distribution and configuration multiple times in a document. Embodiments use the bounding box data for objects predicted by a deep-learning page segmentation model and various heuristics, including symmetry, alignment, and proximity, to first identify sets of objects. Once these sets of objects are identified, the attributes (e.g., font type, font size, text style, color, etc.) and distribution (e.g., number of each object type) of the objects in the sets of object are then compared. Sets of objects with the same or similar attributes and distribution are grouped as a repeating structure group of objects, or repeating groupings of objects. A document can include multiple repeating structure groups of objects, where each repeating structure group of objects has different object attributes and/or object type distributions.

The digital design system of the present disclosure presents improved object detection and processing within documents without structural information, while addressing the limitations of existing techniques. One technical advantage of embodiments of the present disclosure is the ability to identify repeating structure groups of objects in a document, allowing for more robust and efficient document editing. For example, by identifying a repeating structure group of objects, embodiments can automatically propagate an edit (e.g., changes to a font type, text color, etc.) made to an object in one merged object cluster unit in a repeating structure group of objects to all instances of the object in other merged object cluster units in the repeating structure group of objects.

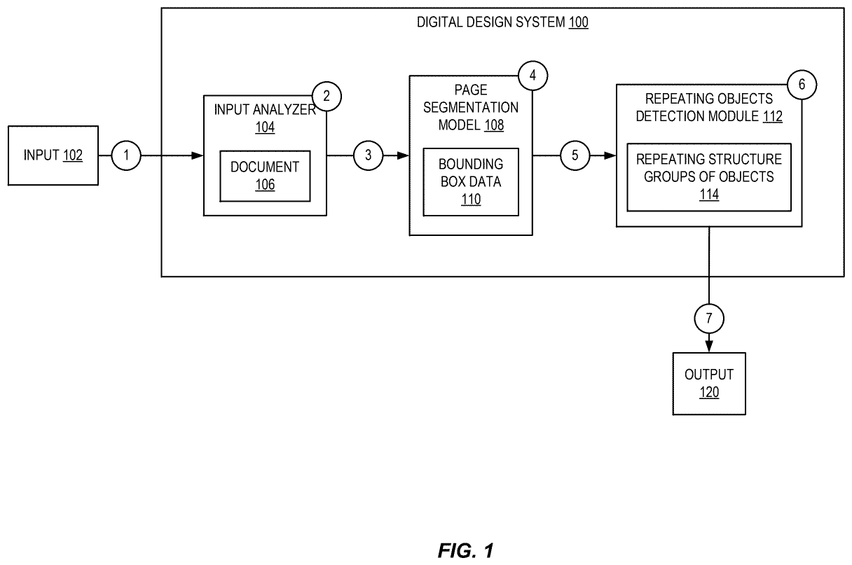

FIG. 1 illustrates a diagram of a process of detecting and processing repeating structure groups of objects in a document in accordance with one or more embodiments. As shown in FIG. 1, a digital design system 100 receives an input 102, as shown at numeral 1. For example, the digital design system 100 receives the input 102 from a user via a computing device or from a memory or storage location. In one or more embodiments, the input 102 includes, at least, document 106 that includes a layout of a plurality of objects (e.g., text, icons, images, etc.). In one or more embodiments, the input 102 can be provided in a graphical user interface (GUI). For example, a user can indicate a storage location (e.g., on a computing device) or a URL to a location storing the document 106.

The digital design system 100 includes an input analyzer 104 that receives the input 102. In some embodiments, the input analyzer 104 is configured to extract the document 106 from the input 102, at numeral 2. The input analyzer 104 then sends the document 106 to a page segmentation model 108, as shown at numeral 3. In one or more embodiments, the page segmentation model 108 is trained to predict the structure of the document 106, at numeral 4. In one or more embodiments, the page segmentation model 108 includes a neural network. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

In one or more embodiments, the page segmentation model 108 uses machine learning to predict the components or objects in document 106. In some embodiments, the page segmentation model 108 generates object information for each component or object predicted by the page segmentation model 108. In one or more embodiments, the object information can include the component or object types of the predicted objects. Example component or object types can include heading, text, figure, footnote, table, and list-items. In other embodiments, the component or object types detected by the page segmentation model can include additional, fewer, or different object types. The page segmentation model 108 further can generate a bounding box for each detected component or object in the document 106 and label each bounding box with its corresponding component or object type. In one or more embodiments, the bounding box data 110 for objects detected by the page segmentation model 108 can include the object type and location data (e.g., coordinates on the page of the document 106). After generating the bounding box data 110, the page segmentation model 108 passes the bounding box data 110 to a repeating objects detection module 112, as shown at numeral 5.

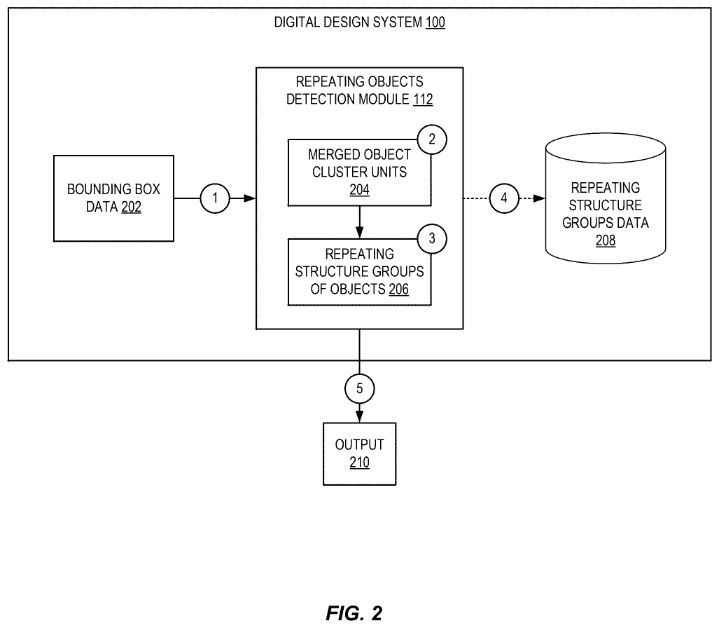

In one or more embodiments, the repeating objects detection module 112 determines the repeating structure groups of objects 114, in the document 106, at numeral 6. In one or more embodiments, the repeating objects detection module 112 first analyzes the bounding box data 110 for the objects predicted by the page segmentation model 108 to determine objects that can be grouped together to form merged object cluster units. The repeating objects detection module 112 then evaluates the object type distribution and object attributes of the merged object cluster units to determine which merged object cluster units can be identified as repeating structure groups of objects 114. Additional details of the repeating objects detection module 112 are described with respect to FIG. 2.

After the repeating objects detection module 112 determines the repeating structure groups of objects 114 in the document 106, data representing the repeating structure groups of objects 114 can be sent as an output 120, as shown at numeral 7. In one or more embodiments, after the process described above in numerals 1-6, the output 120 is sent through a communications channel to the user device or computing device that provided the input 102, to another computing device associated with the user or another user, or to another system or application.

FIG. 2 illustrates a diagram of a repeating objects detection module for identifying repeating structure groups of objects in a document in accordance with one or more embodiments. In one or more embodiments, the repeating objects detection module 112 performs a three-stage process that computes various heuristics (e.g., based on visual/2D principles, such as symmetry, alignment, proximity, etc.) using object information (e.g., the coordinates and types of bounding boxes for each object) to predict repeating structure groups of objects in a document.

As shown in FIG. 2, a repeating objects detection module 112 receives bounding box data 202, as shown at numeral 1. In one or more embodiments, the bounding box data 202 is generated by a page segmentation model (e.g., page segmentation model 108 in FIG. 2). In other embodiments, the bounding box data 202 can be generated externally from the digital design system 100 and provided to the digital design system 100. In one or more embodiments, the bounding box data 202 can include an object type and location data (e.g., coordinates on a page of the document) for each object in the document. Example object types can include heading, text, figure, footnote, table, and list-items.

In one or more embodiments, the repeating objects detection module 112 determines merged object cluster units 204 in the document, at numeral 2. In a first stage evaluation, the repeating objects detection module 112 first identifies the closest pair of objects of the plurality of objects identified by the page segmentation model 108 based on the bounding box data 110. In some embodiments, the repeating objects detection module 112 creates an object store that is initially populated with the objects identified by the page segmentation model 108. In one or more embodiments, the object store can be a list representation of all of the objects detected by the page segmentation model 108. In one or more embodiments, the closest pair of objects is determined based on the bounding boxes of objects in the object store. For example, the closest pair of objects can be determined based on their coordinates on the page in relation to a distance threshold value. In some embodiments, the distance threshold value is set to 0.005. In one or more embodiments, the value of the distance threshold value, and other threshold values discussed herein, is an absolute number for a normalized page of the document where the coordinates of the top left corner of the page is (0, 0), and the coordinates of the bottom right corner of the page is as follows:

$$( \frac{page\_height \_pixels}{max ( page\_height \_pixels , page\_width \_pixels )} , \\ \frac{page\_width \_pixels}{max ( page\_height \_pixels , page\_width \_pixels )} )$$

If there are no objects of the plurality of objects that are within the distance threshold of each other, the distance threshold value can be incrementally increased by a distance threshold offset value until a closest pair of objects that satisfies the increased distance threshold value is identified. In some embodiments, the distance threshold offset value is set to 0.003. In some embodiments, the distance threshold value can be increased by the distance threshold offset value up to a maximum distance threshold value. In such embodiments, the maximum distance threshold value can be designated to prevent objects that are unrelated or too distant from being incorrectly identified as being related. In one or more embodiments, the maximum distance threshold value is set to 0.1. After identifying the closest pair of object of the plurality of objects identified by the page segmentation model 108, the closest pair of objects can be stored together as a first merged object cluster unit. The closest pair of objects identified and stored together as the first merged object cluster unit can then be removed from the object store.

The repeating objects detection module 112 can then iteratively analyze the remaining objects in the plurality of objects identified by the page segmentation model 108 (e.g., the remaining objects in the object store) to determine if any should be added to the first merged object cluster unit. The repeating objects detection module 112 makes this determination by identifying any objects still in the object store that satisfy both the distance threshold value with respect to the closest pair of objects and satisfy an overlap threshold value. For each additional object remaining in the object store, the repeating objects detection module 112 can first determine a distance between the first merged object cluster unit and the bounding box of the additional object. For example, the repeating objects detection module 112 compares the distance between a new bounding box formed to surround the closest pair of objects and each bounding box of each additional object still in the object store that is being evaluated. The repeating objects detection module 112 can then determine an overlap value between the first merged object cluster unit and the bounding box of the additional object. In one or more embodiments, the repeating objects detection module 112 determines a vertical overlap and a horizontal overlap between the first merged object cluster unit and the bounding box of the additional object. The maximum of the vertical overlap and the horizontal overlap is then compared with the overlap threshold value. When an additional object has a determined distance less than the distance threshold value and an overlap value greater than the overlap threshold value, the first merged object cluster unit is updated to include the additional object and the additional object is removed from the object store. In one or more embodiments, the overlap threshold value is set to 0.95. The updated first merged object cluster unit is then used for the analysis of the next additional object remaining in the object store. If either the distance threshold value or the overlap threshold value are not satisfied for an additional object, the additional object is skipped and not merged into the first merged object cluster unit. After analyzing each of the additional objects in the object store to determine whether they can be merged with the first merged object cluster unit, the first merged object cluster unit can be stored in a first set of object clusters (e.g., stage one groups).

In one or more embodiments, the repeating objects detection module 112 repeats the process described above to find additional closest pairs of objects of the plurality of objects identified by the page segmentation model 108. For example, the repeating objects detection module 112 can identify a second closest pair of objects from the objects that were not merged into the first merged object cluster unit generated above (e.g., the objects remaining in the object store). The second closest pair of objects can be stored together as a second merged object cluster unit. The repeating objects detection module 112 then determines if any remaining objects in the object store should be merged into the second merged object cluster unit based on the distance threshold value and the overlap threshold value criteria, as described above. Any such objects are merged into the second merged object cluster unit and removed from the object store. This process of identifying closest pairs of objects can be repeated until no other closest pairs of objects can be identified from the object remaining in the object store (e.g., no pair of objects remaining in the object store satisfy the distance threshold value and the overlap threshold value). Any additional merged object cluster units formed in the first stage evaluation can then be stored in the first set of object clusters.

In one or more embodiments, the repeating objects detection module 112 can then perform a second stage evaluation to check if there are any objects remaining in the object store that can be merged into an already formed merged object cluster unit in the first set of object clusters. The repeating objects detection module 112 first selects an additional object from the object store and checks the distance relative to a “leafToGroupProximity” value, and then checks an overlap value between the additional object and the first merged object cluster unit, as described in the first stage. In one or more embodiments, the “leafToGroupProximity” value is set to 0.04 and the overlap threshold in stage two in set to 0.60. If an additional object satisfies the distance threshold value and the overlap threshold value, the repeating objects detection module 112 then determines whether the first merged object cluster unit and the additional object satisfy a center threshold value. The repeating objects detection module 112 first determines the separate centers of the bounding boxes of each object in the first merged object cluster unit and the center of the additional object, where the centers can be represents as coordinates on the document 106. The repeating objects detection module 112 then averages the centers to obtain a centroid value. The repeating objects detection module 112 then determines the center of the first merged object cluster unit (e.g., the center of a bounding box generated from the objects in the first merged object cluster unit and the additional object) to obtain a center value of the merged group. The repeating objects detection module 112 then determines the Euclidean distance between the center value and the centroid value. If the determined Euclidean distance is greater than a center threshold value, the additional object can be merged with the first merged object cluster unit. In one or more embodiments, the center threshold value is set to 0.04.

In some embodiments, the second stage can also include an intrusion check. In the intrusion check, if there are any additional objects in the object store (excluding an additional object being currently evaluated) whose overlap area with the first merged object cluster unit is greater than a threshold value, the first merged object cluster unit would be marked as not being an eligible unit and skipped.

In some embodiments, the second stage can also evaluate an additional object from the object store with multiple merged object cluster units created in the first stage evaluation. For example, if an additional object is merged with a first merged object cluster unit because it satisfies the criteria described above but is later determined to be closer in proximity to a second merged object cluster unit, the repeating objects detection module 112 can merge the additional object with the second merged object cluster unit due to the closer proximity.

After the second stage, any merged object cluster units that were formed in the first stage (e.g., merged object cluster units stored in the first set of object clusters), which were then expanded to include additional objects in the second stage can be stored in a second set of object clusters (e.g., stage two groups). The merged object cluster units that were formed in the first stage, but not expanded in the second stage, remain stored in the first set of object clusters.

In one or more embodiments, the repeating objects detection module 112 determines the repeating structure groups of objects 206 from the merged object cluster units 204 in the document, at numeral 3. In one or more embodiments, the repeating objects detection module 112 can performs a third stage evaluation to classify the merged object cluster units determined in the first stage and second stage (e.g., any unexpanded merged object cluster units stored in the first set of object clusters and the second set of object clusters) into repeating structure groups of objects. In one or more embodiments, each repeating structure group of objects includes a plurality of merged objects groups that include a same distribution of object types (e.g., heading, text, figure, footnote, table, and list-items, etc.) that also have matching characteristics/attributes (e.g., font type, text size, text style, etc.).

The repeating objects detection module 112 first identifies the candidate merged object cluster units. In one or more embodiments, the candidate merged object cluster units include the merged object cluster units in the second set of object clusters formed in the second stage evaluation. The repeating objects detection module 112 can then evaluate the merged object cluster units in the first set of object clusters formed in the first stage evaluation to determine if any should be added to the candidate merged object cluster units. For example, the candidate merged object cluster units from the first set of object clusters can include any merged object cluster units in the first set of object clusters that were not expanded in the second stage. This is because any merged object cluster units in the first set of object clusters that were expanded in the second stage would already be represented in the second set of object clusters. In one or more embodiments, the repeating objects detection module 112 determines whether any merged object cluster units in the first set of object clusters overlap with any merged object cluster units in the second set of object clusters, within an overlap area threshold value. In such embodiments, when the overlap area between a merged object cluster unit in the first set of object clusters and any merged object cluster units in the second set of object clusters is less than the overlap area threshold value, the merged object cluster unit is considered a candidate merged object cluster unit. Conversely, when the overlap area between a merged object cluster unit in the first set of object clusters and any merged object cluster units in the second set of object clusters is greater than or equal to the overlap area threshold value, the merged object cluster unit is not considered a candidate merged object cluster unit, as it was likely expanded in the second stage and is part of a merged object cluster units in the second set of object clusters.

In one or more embodiments, the repeating objects detection module 112 then analyzes the contents of each of the candidate merged object cluster units to identify a subset of the candidate merged object clusters units that should be grouped as a repeating structure group of objects. In one or more embodiments, the repeating objects detection module 112 evaluates the object type distribution for each candidate merged object cluster unit (e.g., as detected by the page segmentation model 108). For example, a first candidate merged object cluster unit that includes a heading, text, and a figure can be made part of a repeating structure group of objects with a second candidate merged object cluster unit that similarly includes a heading, text, and a figure. In one or more embodiments, as the object type distributions of a plurality of candidate merged object cluster units can be similar, the repeating objects detection module 112 further evaluates the characteristics and/or attributes of the objects to determine whether they can be validated as a repeating structure group of objects. For example, the repeating objects detection module 112 evaluates font types, font size, styles, etc. to determine whether candidate merged object cluster units are similar, and thus should be made part of a repeating structure group of objects.

In one or more embodiments, the repeating objects detection module 112 can manage situations where the page segmentation model 108 produced incorrect predictions (e.g., text was identified as a heading, a heading was identified as text, etc.), which can result in incorrect detection of repeating structure groups of objects. To address such incorrect predictions, the repeating objects detection module 112 selects a repeating structure group of objects, as identified in the third stage, and temporarily expands it vertically and/or horizontally (e.g., up to the height and/or width of a page of a document). After expansion, the repeating objects detection module 112 determines whether there are any remaining candidate merged object cluster units which were not added to a repeating structure group of objects. If any such candidate merged object cluster units exists, the repeating objects detection module 112 determines whether they should be added to an identified repeating structure group of objects. To make this determination, the repeating objects detection module 112 determines the Intersection over Union (IoU) of such candidate merged object cluster units with a repeating structure group of objects, post-expansion. If the IoU is greater than a certain threshold amount, then the corresponding candidate merged object cluster unit is determined to be part of the repeating structure group of objects. If the IoU is not greater than the certain threshold amount, then the corresponding candidate merged object cluster unit is determined to not be part of the repeating structure group of objects. As repeating structure groups of objects normally follow a pattern (e.g., grid layout, horizontal row based layout, vertical column bases layout, etc.), this approach can identify where the page segmentation model 108 produced incorrect predictions. As above, the repeating objects detection module 112 evaluates the characteristics and/or attributes of the objects to determine whether the candidate merged object cluster unit should be added to the repeating structure group of objects.

In one or more embodiments, the data representing the repeating structure groups of objects 206 can be optionally stored in a repeating structure groups data storage 208, as shown at numeral 4. In one or more embodiments, the data representing the repeating structure groups of objects 206 can be alternatively, or additionally, provided as an output 210, as shown at numeral 5.

In one or more embodiments, the digital design system 100 can identify additional merged object cluster units as they are generated (e.g., by a user). For example, the digital design system 100 can identify a new merged object cluster unit and determine that the object type distribution and object attributes of the new merged object cluster unit matches an existing repeating structure group of objects. In such embodiments, the new merged object cluster unit can be added to, or associated with, the existing repeating structure group of objects.

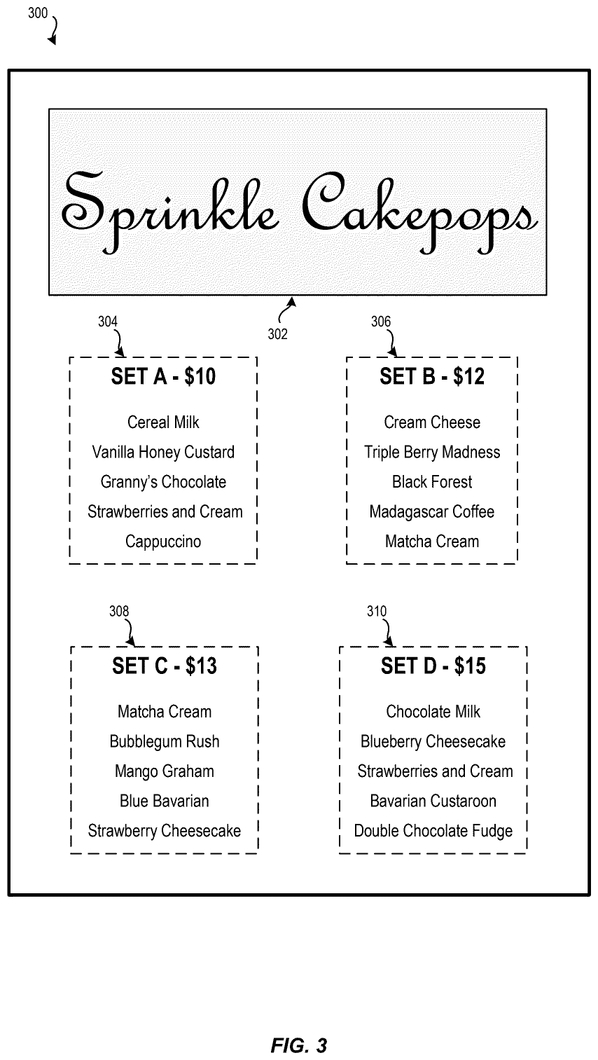

FIGS. 3-6 illustrate an example process of detecting and processing objects in a document to identify repeating structure groups of objects. FIG. 3 illustrates an exemplary document for processing through a digital design system to detect repeating structure groups of objects in accordance with one or more embodiments. As illustrated in FIG. 3, a document 300 includes an image 302 indicating a name of a business (“Sprinkle Cakepops”) and a plurality of text indicating a menu of options for the business. For example, the text within dashed box 304 represents a segment of text related to a “Set A” of grouped menu items, the text within dashed box 306 represents a segment of text related to a “Set B” of grouped menu items, the text within dashed box 308 represents a segment of text related to a “Set C” of grouped menu items, and the text within dashed box 310 represents a segment of text related to a “Set D” of grouped menu items.

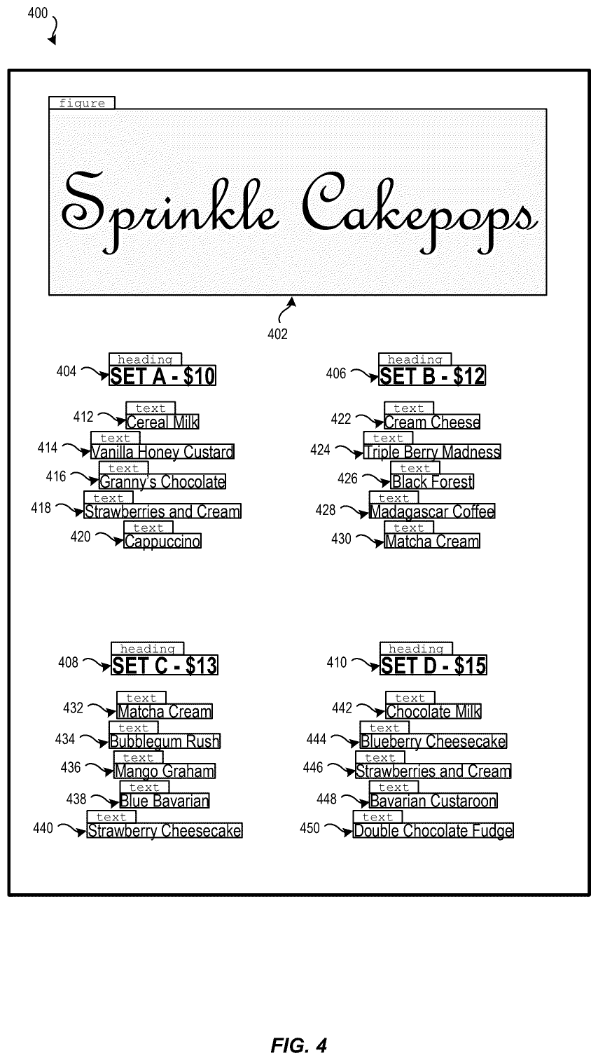

FIG. 4 illustrates the result of processing a document through a page segmentation model in accordance with one or more embodiments. A page segmentation model (e.g., page segmentation model 108 from FIG. 1) is trained to predict the structure of document 400. In one or more embodiments, the page segmentation model 108 includes a neural network. In one or more embodiments, the page segmentation model 108 uses machine learning to segment the document 400 based on predicted component or object types. In some embodiments, the component or object types predicted by the page segmentation model 108 can include heading, text, figure, footnote, table, and list-items.

As illustrated in FIG. 4, the page segmentation model 108 has generated object information, including a bounding box and a label for each object identified in document 400. For example, the page segmentation model 108 has identified and labeled the image 402 as a figure object. The page segmentation model 108 has further identified and labeled object 404, object 406, object 408, and object 410 as heading objects, and each of objects 412-450 have been separately identified and labeled as text objects.

In one or more embodiments, FIG. 4 is a visual representation of the data generated by the page segmentation model 108. In other embodiments, the page segmentation model 108 can alternatively, or additionally, generates data representing the bounding boxes and labels. For example, the page segmentation model 108 can generate a listing of objects that were predicted to be in the document 400. In such embodiments, the listing of objects can include information for each object predicted, including: an indication of the type of object, the coordinates within the document 400 of a bounding box generated for the object, and/or any additional information. Additional information can include binary attribute data for objects. For example, binary attribute data can indicate whether an object is an artifact (e.g., a page header, a page footer, etc.), an aside, etc. The page segmentation model 108 can then store the data in a storage space or data structure.

The data generated by the page segmentation model 108 can then be provided to a repeating objects detection module (e.g., repeating objects detection module 112 in FIG. 1). In one or more embodiments, the repeating objects detection module 112 first identifies the closest pair of objects of the listing of objects predicted by the page segmentation model 108. For example, repeating objects detection module 112 may identify object 412 and object 414 as being the closest pair of objects based on the distance between the two objects and a distance threshold value. Using the process described with respect to FIG. 2, the repeating objects detection module 112 analyzes the distance between the closet pair of objects (object 412 and object 414) and each other object in the listing of objects of document 400 to identify which objects, if any, that are within the threshold distance of object 412 and object 414, and thus should be merged into the group that includes object 412 and object 414. In the example of FIG. 4, the repeating objects detection module 112 can determine that object 404, object 416, object 418, and object 420 should be merged with object 412 and object 414 as a first merged object cluster unit.

Using the remaining object in the listing of objects that were not merged into the first merged object cluster unit, the repeating objects detection module 112 identifies the next closest pair of objects in document 400. For example, repeating objects detection module 112 may identify object 422 and object 424 as being the closest pair of objects based on the distance between the two objects and the distance threshold value. The repeating objects detection module 112 may then similarly identify that object 406, object 426, object 428, and object 430 should be merged with object 422 and object 424 as a second merged object cluster unit. Similarly, the repeating objects detection module 112 can identify object 408, object 432, object 434 object 436, object 438, and object 440 as a third merged object cluster unit, and object 410, object 442, object 444 object 446, object 448, and object 450 as a fourth merged object cluster unit.

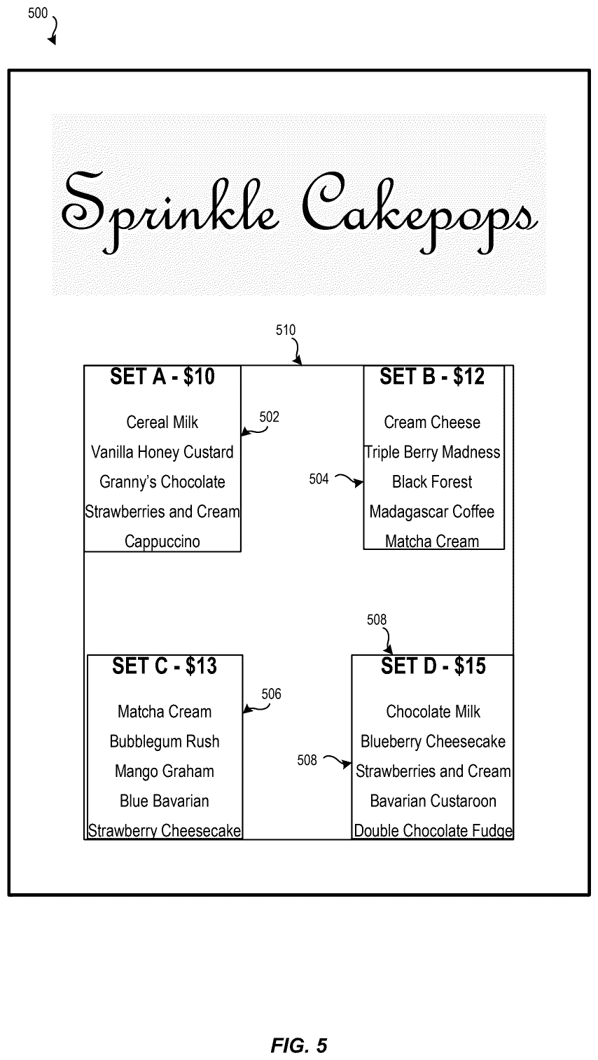

FIG. 5 illustrates the result of processing the objects predicted by a page segmentation model using a repeating objects detection module in accordance with one or more embodiments. As illustrated in FIG. 5, a first merged object cluster unit 502, a second merged object cluster unit 504, a third merged object cluster unit 506, and a fourth merged object cluster unit 508 were identified by the repeating objects detection module 112 as the merged object cluster units in document 500.

In one or more embodiments, the repeating objects detection module 112 can then analyze the contents of each of the merged object cluster units to determine whether they can be grouped together as a repeating structure group of objects, or repeating structure group. In one or more embodiments, the repeating objects detection module 112 evaluates the object type distribution for each candidate merged object cluster unit (e.g., merged object cluster units 502-508). For example, first merged object cluster unit 502, which includes a heading object and five text objects, can be identified as part of a repeating structure group of objects with second merged object cluster unit 504, which also includes a heading object and five text objects. For the same reason, third merged object cluster unit 506 and fourth merged object cluster unit 508 can be identified as part of a repeating structure group of objects with first merged object cluster unit 502 and second merged object cluster unit 504. In one or more embodiments, the repeating objects detection module 112 can further compare font types, font size, styles, etc. of the objects in each merged object cluster unit as an additional check to determine whether the merged object cluster units are properly identified as part of a repeating structure group of objects. The result of this process is identifying merged object cluster units 502-508 as being part of a repeating structure group of objects (e.g., repeating structure group of objects 510). While the example of FIG. 5 includes a single repeating structure group of objects 510, other documents can include multiple repeating structure groups of objects.

In one or more embodiments, the data representing the repeating structure groups of objects 510 can be used to perform modifications to multiple merged object cluster units in the repeating structure groups of objects 510. In such embodiments, the digital design system 100, or another system, can receive input requesting the performance of a modification to an element of a first merged object cluster unit of the repeating structure group of objects 510. For example, modifications can include changes to styles, sizing, location, etc. Using the example of FIGS. 3-5, the digital design system 100 may receive an input to modify the font size and color of the text “SET A—$10” in heading object 404. As object 404 is part of merged object cluster unit 502, which is part of repeating structure group of objects 510, the modification to the text in heading object 404 can be automatically applied or propagated to the corresponding heading objects of other merged object cluster unit (merged object cluster units 504-508) of the repeating structure group of objects 510.

In one or more embodiments, an existing repeating structure group of objects can be used as a template for creating new merged object cluster units. In one embodiment, a new merged object cluster unit can be added to an existing repeating structure group of objects by specifying the contents of the new merged object cluster unit and automating the formatting and stylization of that new merged object cluster unit based on the formatting and stylization of other merged object cluster unit of the existing repeating structure group of objects. In other embodiments, a merged object cluster unit can be replicated in a document by using a single click feature.

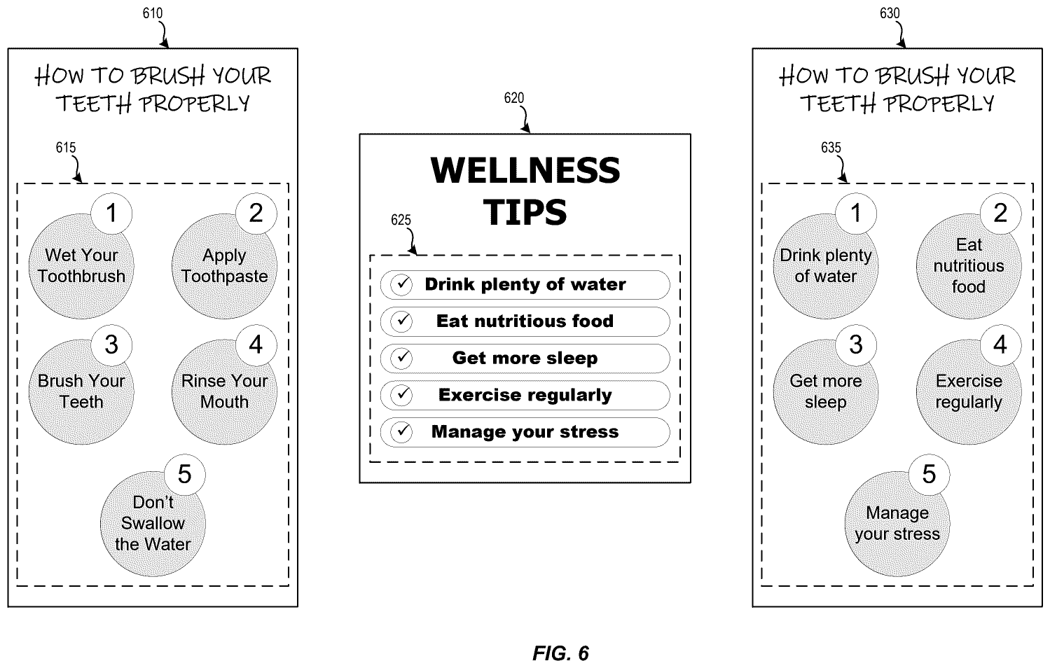

FIG. 6 illustrates a process of applying a structure of a source repeating structure group of objects template to content in a target repeating structure group of objects in accordance with one or more embodiments. In one or more embodiments, the structure defined by a first repeating structure group of objects, including any style, formatting, sizing, font, etc. of objects, can be applied to a second repeating structure group of objects in a same document or in a different document. For example, FIG. 6 illustrates a document 610 with a repeating structure group of objects template 615 and a document 620 with a target repeating structure group of objects 625. The structure of the repeating structure group of objects template 615 can be applied to the content of the target repeating structure group of objects 625, resulting in document 630 with repeating structure group of objects 635. As illustrated in FIG. 6, the text from document 620 has been combined with the structure of the repeating structure group of objects template 615 from document 610, including font styles, font types, and font sizes. As illustrated in FIG. 6, the header for document 630 remains unchanged. In one or more embodiments, the header of document 630 can be modified to match the header of document 620. In other embodiments, repeating structure group of objects 635 can be generated using the repeating structure group of objects template 615 and the text in the target repeating structure group of objects 625, and once generated, can be inserted at the location of the target repeating structure group of objects 625 in document 620. While the number of merged object cluster units in the repeating structure group of objects template 615 and the repeating structure group of objects 625 are the same, in other embodiments, the number of merged object cluster units can be different. In such embodiments, the digital design system can add or remove merged object cluster units based on the number of merged object cluster units in the repeating structure group of objects template 615 or the target repeating structure group of objects 625.

In one or more embodiments, the information representing the repeating structure group of objects can be further used to suggest layout templates for the repeating structure group of objects. For example, the digital design system can generate suggested layouts by applying the merged object groups units of a repeating structure group of objects to an existing layout template.

In one or more embodiments, the information representing the repeating structure group of objects can be further used to automatically adjust page layouts based on a screen size of a computing device (e.g., laptop, smartphone, tablet, etc.) to offer better content flow and readability for the particular device. Using the example of FIG. 5, the information representing merged object groups units 502-508 of repeating structure group of objects 510 can be used to generate a different layout where the merged object groups units 502-508 are organized in a single column for display in a mobile device, (e.g., a smartphone).

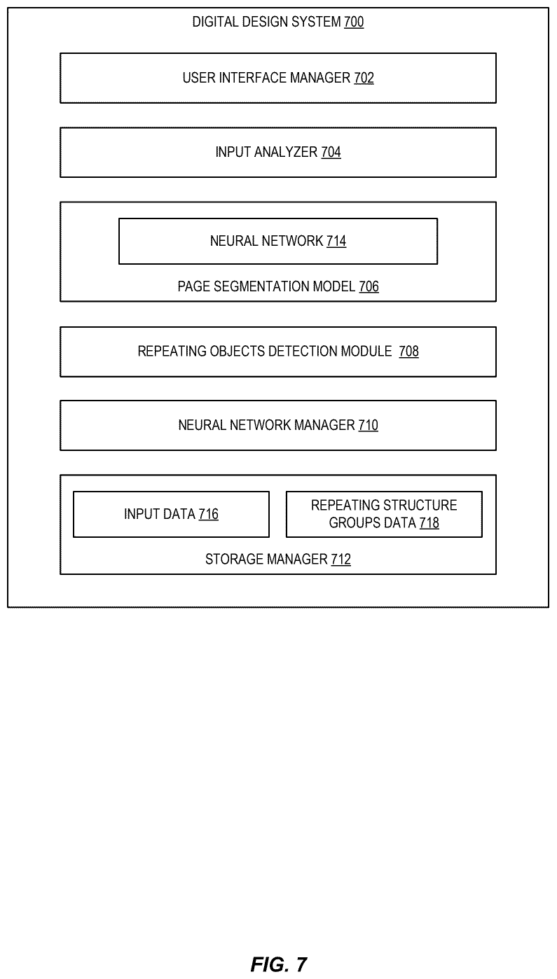

FIG. 7 illustrates a schematic diagram of a digital design system (e.g., “digital design system” described above) in accordance with one or more embodiments. As shown, the digital design system 700 may include, but is not limited to, a user interface manager 702, an input analyzer 704, a page segmentation model 706, a repeating objects detection module 708, a neural network manager 710, and a storage manager 712. The storage manager 712 includes input data 716 and repeating structure groups data 718.

As illustrated in FIG. 7, the digital design system 700 includes a user interface manager 702. For example, the user interface manager 702 allows users to provide input data to the digital design system 700. In some embodiments, the user interface manager 702 provides a user interface through which the user can upload a document (e.g., a PDF document), as discussed above. Alternatively, or additionally, the user interface may enable the user to download the document from a local or remote storage location (e.g., by providing an address, such as a URL or other endpoint, associated with a data source).

As further illustrated in FIG. 7, the digital design system 700 also includes an input analyzer 704 that receives an input (e.g., from the user interface manager 702). The input analyzer 704 analyzes the input received to identify the document from the input.

As further illustrated in FIG. 7, the digital design system 700 also includes a page segmentation model 706 trained to segment an input document. In one or more embodiments, the page segmentation model 706 generates object information for the objects predicted in the input document. In one or more embodiments, example object information can include component or object types detected by the page segmentation model 706, which can include headings, text, list-items, footnotes, figures, tables, etc. In some embodiments, text objects are treated as paragraph objects. The page segmentation model 706 can also generate a bounding box for each detected component or object in the document and label each bounding box with its corresponding component or object type.

In one or more embodiments, the page segmentation model 706 includes a trained neural network 714 to perform the segmentation of the document. In one or more embodiments, a neural network includes deep learning architecture for learning representations of audio and/or video. A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

As further illustrated in FIG. 7, the digital design system 700 also includes a repeating objects detection module 708 configured to analyze the objects identified by the page segmentation model 706 to identify repeating structure groups of objects. The repeating objects detection module 708 first analyzes the bounding box data of objects identified by the page segmentation model 706 to group objects together into merged object cluster units. The repeating objects detection module 708 then compares attributes of the objects within each merged object cluster unit, such as font size, font type, text color, etc., to identify merged object cluster units that include a similar distribution of predicted objects. Once identified, the repeating objects detection module 708 can designate or identify the identified merged object cluster units as being part of a repeating structure group of objects.

As illustrated in FIG. 7, the digital design system 700 also includes a neural network manager 710. Neural network manager 710 may host a plurality of neural networks or other machine learning models, such as neural network 714. The neural network manager 710 may include an execution environment, libraries, and/or any other data needed to execute the machine learning models. In some embodiments, the neural network manager 710 may be associated with dedicated software and/or hardware resources to execute the machine learning models. Although depicted in FIG. 7 as being hosted by a single neural network manager 710, in various embodiments the neural networks may be hosted in multiple neural network managers and/or as part of different components.

As illustrated in FIG. 7, the digital design system 700 also includes the storage manager 712. The storage manager 712 maintains data for the digital design system 700. The storage manager 712 can maintain data of any type, size, or kind as necessary to perform the functions of the digital design system 700. The storage manager 712, as shown in FIG. 7, includes input data 716 and repeating structure groups data 718. In particular, the input data 716 may include a document received by the digital design system 700. The repeating structure groups data 718 can include the output of processing the document through the digital design system 700, including data indicating the repeating structure groups of objects, or repeating structure groups identified in a document.

Each of the components 702-712 of the digital design system 700 and their corresponding elements (as shown in FIG. 7) may be in communication with one another using any suitable communication technologies. It will be recognized that although components 702-712 and their corresponding elements are shown to be separate in FIG. 7, any of components 702-712 and their corresponding elements may be combined into fewer components, such as into a single facility or module, divided into more components, or configured into different components as may serve a particular embodiment.

The components 702-712 and their corresponding elements can comprise software, hardware, or both. For example, the components 702-712 and their corresponding elements can comprise one or more instructions stored on a computer-readable storage medium and executable by processors of one or more computing devices. When executed by the one or more processors, the computer-executable instructions of the digital design system 700 can cause a client device and/or a server device to perform the methods described herein. Alternatively, the components 702-712 and their corresponding elements can comprise hardware, such as a special purpose processing device to perform a certain function or group of functions. Additionally, the components 702-712 and their corresponding elements can comprise a combination of computer-executable instructions and hardware.

Furthermore, the components 702-716 of the digital design system 700 may, for example, be implemented as one or more stand-alone applications, as one or more modules of an application, as one or more plug-ins, as one or more library functions or functions that may be called by other applications, and/or as a cloud-computing model. Thus, the components 702-716 of the digital design system 700 may be implemented as a stand-alone application, such as a desktop or mobile application. Furthermore, the components 702-716 of the digital design system 700 may be implemented as one or more web-based applications hosted on a remote server. Alternatively, or additionally, the components of the digital design system 700 may be implemented in a suite of mobile device applications or “apps.”

As shown, the digital design system 700 can be implemented as a single system. In other embodiments, the digital design system 700 can be implemented in whole, or in part, across multiple systems. For example, one or more functions of the digital design system 700 can be performed by one or more servers, and one or more functions of the digital design system 700 can be performed by one or more client devices. The one or more servers and/or one or more client devices may generate, store, receive, and transmit any type of data used by the digital design system 700, as described herein.

In one implementation, the one or more client devices can include or implement at least a portion of the digital design system 700. In other implementations, the one or more servers can include or implement at least a portion of the digital design system 700. For instance, the digital design system 700 can include an application running on the one or more servers or a portion of the digital design system 700 can be downloaded from the one or more servers. Additionally, or alternatively, the digital design system 700 can include a web hosting application that allows the client device(s) to interact with content hosted at the one or more server(s).

For example, upon a client device accessing a webpage or other web application hosted at the one or more servers, in one or more embodiments, the one or more servers can provide access to one or more files including documents (e.g., PDF documents) stored at the one or more servers. The one or more servers can then automatically perform the methods and processes described above to identify and process repeating structure groups of objects in the documents.

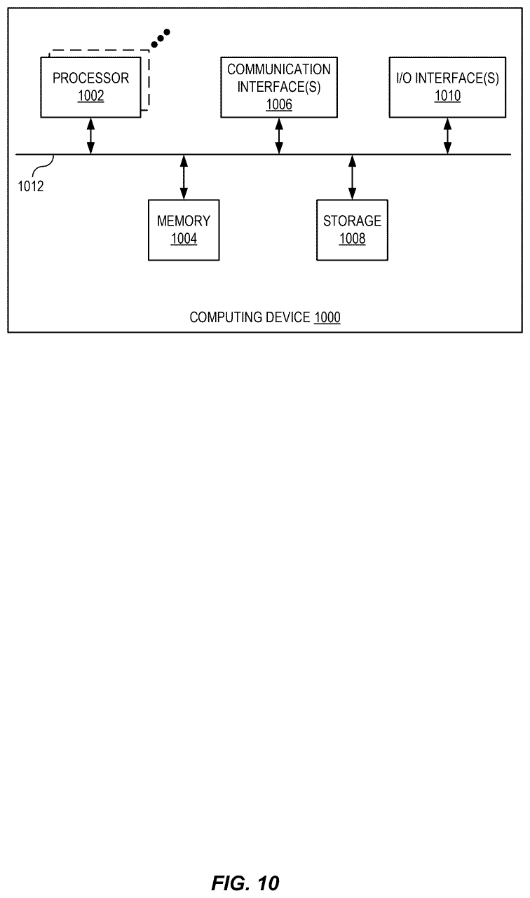

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 10. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 10.

The server(s) may include one or more hardware servers (e.g., hosts), each with its own computing resources (e.g., processors, memory, disk space, networking bandwidth, etc.) which may be securely divided between multiple customers (e.g., client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 10.

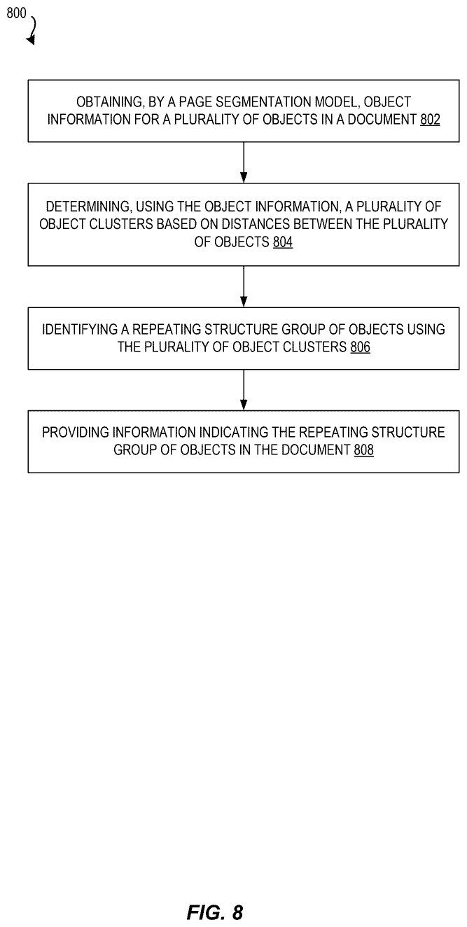

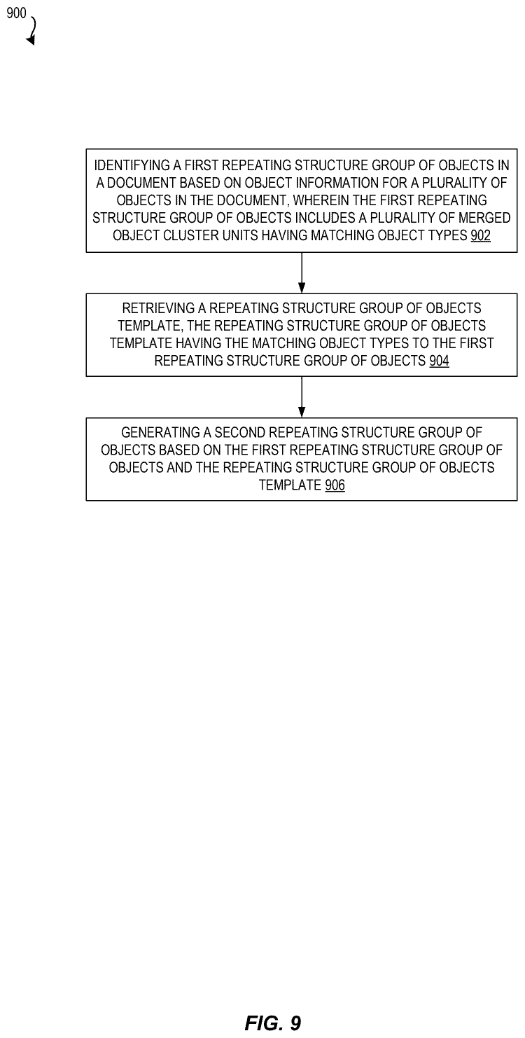

FIGS. 1-7, the corresponding text, and the examples, provide a number of different systems and devices that identify repeating structure groups of objects in a document. In addition to the foregoing, embodiments can also be described in terms of flowcharts comprising acts and steps in a method for accomplishing a particular result. For example, FIGS. 8 and 9 illustrate a flowchart of an exemplary method in accordance with one or more embodiments. The methods described in relation to FIGS. 8 and 9 may be performed with fewer or more steps/acts or the steps/acts may be performed in differing orders. Additionally, the steps/acts described herein may be repeated or performed in parallel with one another or in parallel with different instances of the same or similar steps/acts.

FIG. 8 illustrates a flowchart of a series of acts in a method 800 of detecting and processing repeating structure groups of objects in a document in accordance with one or more embodiments. In one or more embodiments, the method 800 is performed in a digital medium environment that includes the digital design system 700. The method 800 is intended to be illustrative of one or more methods in accordance with the present disclosure and is not intended to limit potential embodiments. Alternative embodiments can include additional, fewer, or different steps than those articulated in FIG. 8.

As illustrated in FIG. 8, the method 800 includes an act 802 of obtaining, by a page segmentation model, object information for a plurality of objects in a document. In one or more embodiments, the page segmentation model is a deep-learning model for page-decomposition/page-analysis. In some embodiments, the page segmentation is the YODA model. The page segmentation model can output the object information, indicating a plurality of different object types (e.g., paragraphs, headings, list-items, footnotes, figures, tables, etc.). In one or more embodiments, the page segmentation model generates bounding box data for the plurality of objects, which can include coordinate data for each object representing the object's location on a page of the document.

As illustrated in FIG. 8, the method 800 includes an act 804 of determining, using the object information, a plurality of object clusters based on distances between the plurality of objects. In one or more embodiments, the digital design system determines the first set of object clusters in a first stage evaluation and determines the second set of object clusters in a second stage evaluation.

In one or more embodiments, in the first stage evaluation, the digital design system first identifies a first closest pair of objects of the plurality of objects as a first merged object cluster unit. In some embodiments, the first closest pair of objects is determined based on the locating of bounding boxes for the plurality of objects and a distance threshold value that can be iteratively increased by an offset value up to a maximum distance threshold value. The first closest pair of objects are then removed from the plurality of objects and the digital design system then performs an iterative evaluation of the remaining objects in the plurality of objects with the first merged object cluster unit to determine whether any additional objects should be included in, or merged into, the first merged object cluster unit. In one or more embodiments, the digital design determines a distance between an additional object and the first merged object cluster unit. If the determined distance is within the distance threshold value, the additional object is added to the merged object cluster unit and removed from the plurality of objects. If the determined distance is not within the distance threshold value, the additional object is not added to the first merged object cluster unit and is kept in the plurality of objects for possible inclusion in a different merged object cluster unit. This process can be repeated until all objects in the plurality of objects are evaluated against the first merged object cluster unit. The first merged object cluster unit can then be stored in the first set of object clusters. The digital design system can then repeat the process described above with the remaining objects in the plurality of objects to identify additional merged object cluster units. Any additional merged object cluster units are stored in the first set of object clusters.

In one or more embodiments, in the second stage evaluation, the digital design system performs an additional check or evaluation between the merged object cluster units in the first set of object clusters and the object remaining in the plurality of objects (e.g., the objects not in any of the merged object cluster units in the first set of object clusters). In one or more embodiments, for each object in the plurality objects not in the first set of object clusters, the digital design system determines the distances between the object and each merged object cluster units in the first set of object clusters. If the digital design system identifies a merged object cluster unit having the closest distance to the object that also satisfies the distance threshold value, the identified merged object cluster unit is updated to include the object. The digital design system then validates the updated merged object cluster unit. In one or more embodiments, the updated merged object cluster unit is validated by first determining a center point of the updated merged object cluster unit and a centroid point based on an average of the center points of each object in the updated merged object cluster unit. The digital design system then determines a Euclidean distance between the determined center point and the centroid point. When then Euclidean distance is less than a second threshold value, the updated merged object cluster unit is validated. Once validated, the updated merged object cluster unit can be stored in the second set of object clusters. The digital design system can then repeat the process described above with the remaining objects in the plurality of objects to identify additional merged object cluster units that should be updated and added to the second set of object clusters.

As illustrated in FIG. 8, the method 800 includes an act 806 of identifying a repeating structure group of objects using the plurality of object clusters. In one or more embodiments, the digital design system first identifies candidate merged object cluster units. The candidate merged object cluster units include the merged object cluster units stored in the second set of object clusters and the merged object cluster units in the first set of object clusters that do not overlap with merged object cluster units in the second set of object clusters. Merged object cluster units that were originally in the first set of object clusters and then expanded in the second stage can be omitted as they are already represented in the second set of object clusters. In one or more embodiments, the digital design system can identify the subset of the candidate merged object cluster units that have matching object type distributions and matching object attributes as a repeating structure group of objects. Based on the objects in a page of the document, the digital design system can identify multiple repeating structure groups of objects, each with its own different set of merged object cluster units.

As illustrated in FIG. 8, the method 800 includes an act 808 of providing information indicating the repeating structure group of objects in the document. In one or more embodiments, the information indicating the repeating structure group of objects can be used by the digital design system, or downstream applications, to edit the document. For example, a modification made to an object in a merged object cluster unit of a repeating structure group of objects can be automatically propagated to any other corresponding instances of the object in other merged object cluster units of the repeating structure group of objects.

FIG. 9 illustrates a flowchart of a series of acts in a method 900 of generating repeating structure group of objects using a repeating structure group of objects template in accordance with one or more embodiments. In one or more embodiments, the method 900 is performed in a digital medium environment that includes the digital design system 700. The method 900 is intended to be illustrative of one or more methods in accordance with the present disclosure and is not intended to limit potential embodiments. Alternative embodiments can include additional, fewer, or different steps than those articulated in FIG. 9.

As illustrated in FIG. 9, the method 900 includes an act 902 of identifying a first repeating structure group of objects in a document based on object information for a plurality of objects in the document, wherein the first repeating structure group of objects includes a plurality of merged object cluster units having matching object types. In one or more embodiments, the first repeating structure group of objects is identified as described with respect to FIG. 8.

As illustrated in FIG. 9, the method 900 includes an act 904 retrieving a repeating structure group of objects template, the repeating structure group of objects template having the matching object types to the first repeating structure group of objects. In one or more embodiments, the digital design system includes interface elements (e.g., buttons, selectors, etc.) to allow a user to modify a repeating structure group of objects to conform or match other repeating structure group of objects using a repeating structure group of objects template.

In one or more embodiments, the digital design system can identify at least one existing repeating structure group of objects template from one or more repeating structure group of objects templates that has matching object type distributions to the first repeating structure group of objects. For example, if the first repeating structure group of objects includes object cluster units with five text box objects and a heading object, the digital design system can identify and retrieve a repeating structure group of objects template that also includes object cluster unit with five text box objects and a heading object. In such embodiments, the digital design system can display the at least one existing repeating structure group of objects template to a user for selection.

As illustrated in FIG. 9, the method 900 includes an act 906 generating a second repeating structure group of objects based on the first repeating structure group of objects and the repeating structure group of objects template. In some embodiments, based on a user selection of the repeating structure group of objects template, the digital design system can generate the second repeating structure group of objects that has object cluster units having a structure of the repeating structure group of objects template. In one or more embodiments, the object cluster units of the second repeating structure group of objects can then be modified to include the contents (e.g., text) of the object cluster units of the first repeating structure group of objects to the repeating structure group of objects template. For example, the style, formatting, sizing, font, etc. of text and objects in the first repeating structure group of objects can be modified to match the style, formatting, sizing, font, etc. of text and objects of the repeating structure group of objects template to generate the second repeating structure group of objects.

In some embodiments, the second repeating structure group of objects can be generated in a different document from the document in which the first repeating structure group of objects was created. In some embodiments, the repeating structure group of objects template can be based on repeating structure groups of objects in a different document from the document in which the first repeating structure group of objects was created.

In some embodiments, the digital design system can identify repeating structure group of objects templates that have object cluster units with similar, but not matching object type distributions. For example, the digital design system can identify and retrieve a repeating structure group of objects template where the object cluster units include a heading object and a different number of text box objects. In such embodiments, the digital design system can add or remove additional text box objects from the object cluster units to match the object type distribution of the object cluster units of first repeating structure group of objects.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates, in block diagram form, an exemplary computing device 1000 that may be configured to perform one or more of the processes described above. One will appreciate that one or more computing devices such as the computing device 1000 may implement the digital design system. As shown by FIG. 10, the computing device can comprise a processor 1002, memory 1004, one or more communication interfaces 1006, a storage device 1008, and one or more I/O devices/interfaces 1010. In certain embodiments, the computing device 1000 can include fewer or more components than those shown in FIG. 10. Components of computing device 1000 shown in FIG. 10 will now be described in additional detail.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1008 and decode and execute them. In various embodiments, the processor(s) 1002 may include one or more central processing units (CPUs), graphics processing units (GPUs), field programmable gate arrays (FPGAs), systems on chip (SoC), or other processor(s) or combinations of processors.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1004 may be internal or distributed memory.

The computing device 1000 can further include one or more communication interfaces 1006. A communication interface 1006 can include hardware, software, or both. The communication interface 1006 can provide one or more interfaces for communication (such as, for example, packet-based communication) between the computing device and one or more other computing devices 1000 or one or more networks. As an example, and not by way of limitation, communication interface 1006 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can comprise hardware, software, or both that couples components of computing device 1000 to each other.

The computing device 1000 includes a storage device 1008 includes storage for storing data or instructions. As an example, and not by way of limitation, storage device 1008 can comprise a non-transitory storage medium described above. The storage device 1008 may include a hard disk drive (HDD), flash memory, a Universal Serial Bus (USB) drive or a combination these or other storage devices. The computing device 1000 also includes one or more input or output (“I/O”) devices/interfaces 1010, which are provided to allow a user to provide input to (such as user strokes), receive output from, and otherwise transfer data to and from the computing device 1000. These I/O devices/interfaces 1010 may include a mouse, keypad or a keyboard, a touch screen, camera, optical scanner, network interface, modem, other known I/O devices or a combination of such I/O devices/interfaces 1010. The touch screen may be activated with a stylus or a finger.

The I/O devices/interfaces 1010 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1010 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
obtaining, by a page segmentation model, object information for a plurality of objects in a document;
determining, using the object information, a plurality of object clusters based on distances between the plurality of objects;
identifying a repeating structure group of objects using the plurality of object clusters; and
providing information indicating the repeating structure group of objects in the document.

2. The method of claim 1, wherein determining the plurality of object clusters based on the distances between the plurality of objects further comprises:
identifying a first closest pair of objects of the plurality of objects as a first merged object cluster unit, wherein a first distance between the first closest pair of objects is less than a distance threshold;
removing the first closest pair of objects from the plurality of objects;
iteratively determining first additional objects in the plurality of objects to merge with the first merged object cluster unit; and
storing the first merged object cluster unit in a first set of object clusters of the plurality of object clusters.

3. The method of claim 2, wherein iteratively determining the first additional objects in the plurality of objects to merge with the first merged object cluster unit comprises:
for each first additional object in the plurality of objects:
determining a second distance between the first additional object and the first merged object cluster unit,
updating the first merged object cluster unit to include the first additional object when the second distance between the first additional object and the first merged object cluster unit is less than the distance threshold, and
removing the first additional object from the plurality of objects.

4. The method of claim 3, further comprising:
identifying a second closest pair of objects of the plurality of objects as a second merged object cluster unit, wherein a third distance between the second closest pair of objects is less than the distance threshold;
removing the second closest pair of objects from the plurality of objects;
iteratively determining second additional objects in the plurality of objects to merge with the second merged object cluster unit; and
storing the second merged object cluster unit in the first set of object clusters.

5. The method of claim 4, wherein iteratively determining the second additional objects in the plurality of objects to merge with the second merged object cluster unit comprises:
for each second additional object in the plurality of objects:
determining a fourth distance between the second additional object and the second merged object cluster unit,
updating the second merged object cluster unit to include the second additional object when the fourth distance between the second additional object and the second merged object cluster unit is less than the distance threshold, and
removing the second additional object from the plurality of objects.

6. The method of claim 2, wherein identifying the first closest pair of objects of the plurality of objects as the first merged object cluster unit, wherein the first distance between the first closest pair of objects is less than the distance threshold further comprises:
iteratively increasing the distance threshold by an offset value up to a maximum distance threshold value.

7. The method of claim 2, further comprising:
determining a second set of object clusters of the plurality of object clusters based on the distances between the first set of object clusters and objects in the plurality of objects not in the first set of object clusters by:
for each object in the plurality of objects not in the first set of object clusters:
determining distances between the object and each merged object cluster units in the first set of object clusters,
identifying a merged object cluster unit having a closest distance to the object and that satisfies a distance threshold,
updating the merged object cluster unit to include the object,
validating the updated merged object cluster unit, and
storing the updated merged object cluster unit in the second set of object clusters based on validating the updated merged object cluster unit.

8. The method of claim 7, wherein validating the updated merged object cluster unit comprises:
determining a center point of the updated merged object cluster unit and a centroid point based on an average of the center points of each object in the updated merged object cluster unit;
determining a Euclidean distance between the determined center point and the centroid point; and
validating the updated merged object cluster unit when the Euclidean distance is less than a second threshold value.

9. The method of claim 7, wherein identifying the repeating structure group of objects using the plurality of object clusters comprises:
identifying the second set of object clusters and merged object cluster units in the first set of object clusters not overlapping with merged object cluster units in the second set of object clusters as candidate merged object cluster units; and
identifying a subset of the candidate merged object cluster units having matching object type distributions and matching object attributes as the repeating structure group of objects.

10. The method of claim 1, further comprising:
performing a modification to a first element of a first merged object cluster unit of the repeating structure group of objects based on an input; and
automatically applying the modification to the first element of a second merged object cluster unit of the repeating structure group of objects.

11. A non-transitory computer-readable medium storing executable instructions, which when executed by a processing device, cause the processing device to perform operations comprising:
obtaining, by a page segmentation model, object information for a plurality of objects in a document;
determining, using the object information, a plurality of object clusters based on distances between the plurality of objects;
identifying a repeating structure group of objects using plurality of object clusters; and
providing information indicating the repeating structure group of objects in the document.

12. The non-transitory computer-readable medium of claim 11, wherein the instructions to determine the plurality of object clusters based on the distances between the plurality of objects further comprise:
identifying a first closest pair of objects of the plurality of objects as a first merged object cluster unit, wherein a first distance between the first closest pair of objects is less than a distance threshold;
removing the first closest pair of objects from the plurality of objects;
iteratively determining first additional objects in the plurality of objects to merge with the first merged object cluster unit; and
storing the first merged object cluster unit in a first set of object clusters of the plurality of object clusters.

13. The non-transitory computer-readable medium of claim 12, wherein the instructions to iteratively determine the first additional objects in the plurality of objects to merge with the first merged object cluster unit further comprise:
for each first additional object in the plurality of objects:
determining a second distance between the first additional object and the first merged object cluster unit,
updating the first merged object cluster unit to include the first additional object when the second distance between the first additional object and the first merged object cluster unit is less than the distance threshold, and
removing the first additional object from the plurality of objects.

14. The non-transitory computer-readable medium of claim 12, storing instructions that further cause the processing device to perform operations comprising:
determining a second set of object clusters of the plurality of object clusters based on the distances between the first set of object clusters and objects in the plurality of objects not in the first set of object clusters by:
for each object in the plurality of objects not in the first set of object clusters:
determining distances between the object and each merged object cluster units in the first set of object clusters,
identifying a merged object cluster unit having a closest distance to the object and that satisfies a distance threshold,
updating the merged object cluster unit to include the object,
validating the updated merged object cluster unit, and
storing the updated merged object cluster unit in the second set of object clusters based on validating the updated merged object cluster unit.

15. The non-transitory computer-readable medium of claim 14, wherein the instructions to identify the repeating structure group of objects using the plurality of object clusters further comprise:
identifying the second set of object clusters and merged object cluster units in the first set of object clusters not overlapping with merged object cluster units in the second set of object clusters as candidate merged object cluster units; and
identifying a subset of the candidate merged object cluster units having matching object type distributions and matching object attributes as the repeating structure group of objects.

16. A system comprising:
a memory component; and
a processing device coupled to the memory component, the processing device to perform operations comprising:
identifying a first repeating structure group of objects in a document based on object information for a plurality of objects in the document, wherein the first repeating structure group of objects includes a plurality of merged object cluster units having matching object types;
retrieving a repeating structure group of objects template, the repeating structure group of objects template having the matching object types to the first repeating structure group of objects; and
generating a second repeating structure group of objects based on the first repeating structure group of objects and the repeating structure group of objects template.

17. The system of claim 16, wherein the operations of identifying the first repeating structure group of objects in the document based on the object information for the plurality of objects in the document further comprise:
identifying a first closest pair of objects of the plurality of objects as a first merged object cluster unit, wherein a first distance between the first closest pair of objects is less than a distance threshold;
removing the first closest pair of objects from the plurality of objects;
iteratively determining first additional objects in the plurality of objects to merge with the first merged object cluster unit; and
storing the first merged object cluster unit in a first set of object clusters of a plurality of object clusters.

18. The system of claim 17, wherein the processing device performs further operations comprising:
determining a second set of object clusters of the plurality of object clusters based on the distances between the first set of object clusters and objects in the plurality of objects not in the first set of object clusters by:
for each object in the plurality of objects not in the first set of object clusters:
determining distances between the object and each merged object cluster units in the first set of object clusters,
identifying a merged object cluster unit having a closest distance to the object and that satisfies a distance threshold,
updating the merged object cluster unit to include the object,
validating the updated merged object cluster unit, and
storing the updated merged object cluster unit in the second set of object clusters based on validating the updated merged object cluster unit.

19. The system of claim 18, wherein the operations of identifying the first repeating structure group of objects in the document based on the object information for the plurality of objects in the document further comprise:
identifying the second set of object clusters and merged object cluster units in the first set of object clusters not overlapping with merged object cluster units in the second set of object clusters as candidate merged object cluster units; and
identifying a subset of the candidate merged object cluster units having matching object type distributions and matching object attributes as the first repeating structure group of objects.

20. The system of claim 16, wherein the operations of generating a second repeating structure group of objects based on the first repeating structure group of objects and the repeating structure group of objects template further comprise:
creating a structure of the second repeating structure group of objects based on a structure of the repeating structure group of objects; and
applying contents of the first repeating structure group of objects to the structure of the second repeating structure group of objects.
